(19) United States
(12) Patent Application Publication
(10) Pub. No.: US 2008/0096709 A1
(43) Pub. Date: Apr. 24, 2008

(54) Chain transmission device

(75) Inventor: Junya Kurohata, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/879,121

(22) Filed: Jul. 16, 2007

(30) Foreign Application Priority Data
Oct. 18, 2006 (JP) 2006-284224

(51) Int. Cl. F16G 13/06

(52) U.S. Cl. 474/206

(57) ABSTRACT

A chain transmission comprises a composite chain having a set of sprocket-engaging rollers disposed between sets of link plates having sprocket-engaging teeth, and a sprocket having three sets of sprocket teeth. As the chain approaches the sprocket, a rear flank of a link plate tooth first comes into contact with a sprocket tooth, and slides thereon. However, as the rollers become seated, the flanks of the link plate teeth become separated from the sprocket teeth.

### CROSS-REFERENCE TO RELATED APPLICATION

This application claims priority on the basis of Japanese patent application 2006-284224, filed Oct. 18, 2006. The disclosure of Japanese application 2006-284224 is hereby incorporated by reference.

### FIELD OF THE INVENTION

This invention relates to a chain transmission, which transmits power from a chain to a sprocket or from a sprocket to a chain. The chain transmission can be used, for example, as a timing chain to operate the intake and exhaust valves of a four cycle engine, or to drive auxiliary equipment such as an oil pump or the like. The invention relates particularly to a chain transmission comprising a composite chain, having not only rollers or bushings for engagement with a sprocket, but also link plates having sprocket-engaging teeth. The transmission also includes a sprocket having a set of teeth for engaging the rollers or bushings, and a set of teeth for engaging the teeth of the link plates.

### BACKGROUND OF THE INVENTION

Chain transmissions using silent chains, and chain transmissions using roller chains or rollerless bushing chains, are well known. Furthermore, a chain transmission comprising a composite chain having rollers as well as toothed link plates is also known. The latter type of chain, which is described in Japanese Examined Patent (Koukoku) Publication No. Sho. 59-30936, is depicted in FIG. 8.

As shown in FIG. 8, a composite chain 31 comprises sets of link plates 32 and 33 disposed in overlapping relationship along both sides of the chain, and rollers 34 between the sets of link plates. The link plates 32, link plates 33, and rollers 34 are connected by connecting pins 35. Each link plate 32 has a pair of teeth so that link plates 32 form a silent chain. Link plates 33 have no teeth.

In the composite chain transmission, when the composite chain 31 is wound around a sprocket, teeth of the link plates 32 mesh with sprocket teeth, and the rollers 34 also mesh with sprocket teeth. When the rollers 34 are seated on a sprocket, the outer flanks of the teeth of the link plates 32 come into contact with sprocket teeth and are seated thereon.

A silent chain is generally advantageous over a roller chain in that it has better strength and achieves a reduction in noise. However, the silent chain is subject to elongation due to wear of the connecting pins. The elongation of a silent chain is typically greater than that of a roller chain. On the other hand, in a chain transmission using a known roller chain, the roller chain exhibits better fatigue strength along with resistance to wear elongation. However, even in a roller chain, increasing its strength is difficult because of the difficulty of increasing the strength of the rollers. Moreover the meshing noise produced when a roller chain meshes with a sprocket is greater than in the case of a silent chain.

In the conventional composite chain transmission, since both outside flanks of the link plate teeth come into seating contact with sprocket teeth, the connecting pins that are press-fit in pin holes in the link plates tend to become loosened by pivotal movement of the link plates on seating of a flank after the start of engagement and just before disengagement. Wear occurs between the pin hole and the connecting pin, wear elongation of the chain is promoted, and the strength of the chain is reduced. Also, since the chain has four link plates with teeth and four link plates without teeth, overlapping one another in the widthwise direction of the chain, the mass of the chain is relatively high, and its cost is also high.

An object of the invention is to solve the above-described problems in the prior art, and to provide a chain transmission, which exhibits the advantages of a silent chain as well as those of a roller chain, which can avoid wear elongation and reduction of strength, and which also achieves noise reduction and weight reduction.

### SUMMARY OF THE INVENTION

In the chain transmission according to the invention, the chain comprises alternating outer and inner links. Each outer link comprises a pair of spaced outer link plates connected by a pair of pins the ends of which are fitted to pin holes in the outer link plates. Each inner link comprises a pair of spaced inner link plates connected by a pair of bushings fitted into bushing holes in the inner link plates. Each pin of an outer link extends rotatably though a bushing of an adjacent inner link, so that the chain comprises overlapping inner and outer link plates on one side of the chain, overlapping inner and outer link plates on the opposite side of the chain, and sprocket-engaging elements extending, between the inner link plates, from one side of the chain to the other. The sprocket engaging elements can be either the bushings by themselves, or the bushings together with rollers rotatable on the bushings. Sprocket-engaging teeth are formed on the inner and outer link plates.

The sprocket of the chain transmission has first and second sets of sprocket teeth. Teeth of the first set are in meshing engagement with sprocket-engaging teeth on the inner and outer link plates on one side of the chain, and teeth of the second set are in meshing engagement with sprocket-engaging teeth on the inner and outer link plates on the opposite side of the chain. The sprocket has a third set of teeth disposed between the first and second sets of teeth and in meshing engagement with elements of the sprocket-engaging elements, said elements being seatable between teeth of said third set as they come into meshing engagement with the teeth of the third set.

A rear flank of a tooth of each link plate is engageable with a forward flank of a tooth of one of the first and second sets of sprocket teeth as the link plates first come into contact with the sprocket, and, as the sprocket-engaging elements of each link become seated between teeth of the third set, the flanks of the link plates thereof are spaced away from the teeth of the first and second sets of sprocket teeth.

In one preferred embodiment of the invention, each of the link plates has two sprocket-engaging teeth formed thereon, and the rear flank of a tooth of each link plate engageable with a forward flank of a tooth of one of the first and second sets of sprocket teeth is a rear flank of a forward one of the two teeth thereof with respect to the direction of travel of the chain. In another preferred embodiment, each link plate has a single tooth formed thereon, and preferably, the teeth of the first, second and third sets of sprocket teeth have the same angular pitch, and the teeth of the third set are shifted by ½ the pitch angle relative to the teeth of the first and second sets.

Since the chain transmission is composed of a chain in which the ends of the connecting pins are fitted into pin holes in the outer link plates, and bushings are fitted into holes in the inner link plates, and the inner and outer links are connected by fitting the connecting pins into the bushings, the surface pressure between the connecting pin and the bushings is low, and the links pivot relative to each other smoothly. Thus, wear elongation of the chain is suppressed.

Furthermore, since rear tooth flanks of the toothed link plates engage sprocket teeth at the start of engagement, but all the link plate tooth flanks separate from the sprocket teeth when the rollers become seated, noise at the start of meshing is suppressed, and, at the same time, wear of the sprocket teeth is suppressed.

Since the link plate teeth are spaced away from the sprocket teeth when the bushings or rollers are seated, the fatigue strength of the chain can be the same as that of the roller chain. Furthermore, since only four link plates overlap in the chain width direction, the chain can be light in weight and low in cost.

In the chain, the surface pressure between the connecting pin and the bushing is low, and the pivotal movement of the links is smooth. Thus, wear elongation of the chain is suppressed.

In the case in which the link plates have a single, angle-shaped tooth, the same advantages are achieved as in the case of link plates having two teeth. In addition, when the sprocket teeth engaged by the rollers are shifted by ½ the angular pitch relative to the sprocket teeth engaged by the single, angle-shaped teeth, at the start of meshing with a sprocket, the chordal vibration of the span of chain approaching the sprocket due to a polygonal movement of the chain can be reduced. As a result, vibration noise is reduced.

### BRIEF DESCRIPTION OF THE DRAWINGS

FIG. 1 is a plan view, partly in cross-section, of a chain used in a chain transmission according to a first embodiment of the invention;

FIG. 2 is a front elevational view of a sprocket used with the chain of FIG. 1;

FIG. 3 is a schematic side elevational view illustrating the relationship between the chain of FIG. 1 and the sprocket of FIG. 2;

FIG. 4a is a schematic side elevational view illustrating the meshing of a link plate with the sprocket;

FIG. 4b is schematic diagram illustrating the polygonal movement of the chain;

FIG. 5 is schematic side elevational view illustrating the relationship between a chain and sprocket in a transmission according to a second embodiment of the invention;

FIG. 6a a schematic side elevational view illustrating the meshing of a link plate with the sprocket in the second embodiment;

FIG. 6b is schematic diagram illustrating the polygonal movement of the chain in the second embodiment; and

FIG. 7 is a plan view of a portion of a conventional composite chain.

### DETAILED DESCRIPTION OF THE PREFERRED EMBODIMENTS

The chain transmission according to the first embodiment of the invention comprises a composite chain and a set of sprockets. In the first embodiment, each of the link plates is formed with a pair of teeth.

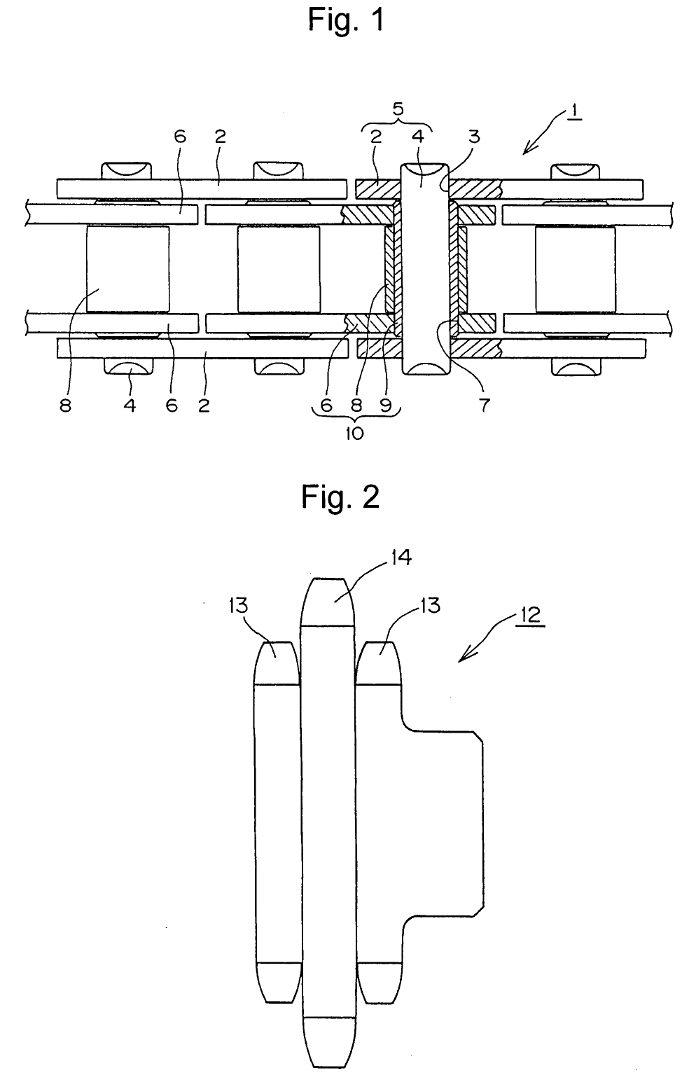

As shown in FIG. 1, the chain 1 comprises outer links 5 and inner links 10 arranged in alternating relationship along the length of the chain. Each outer link comprises a pair of opposite link plates 2 connected by a pair of connecting pins 4. The ends of the connecting pins are fitted into pin holes 3 in the outer link plates 2. Each inner link 10 comprises a pair of inner link plates 6, connected by bushings 9 which are fitted into bushing holes 9 in the inner link plates. Rollers 8 are situated on the bushings between the inner link plates, and are rotatable on the bushings. Pins of the outer links extend through bushings of the inner links. The pins and bushings connect the inner and outer links in alternating relationship to produce a transmission chain in the form of an endless loop. The pins are rotatable in the bushings so that the links are articulable relative to one another, thereby allowing the chain to flex so that it can be wound around a sprocket.

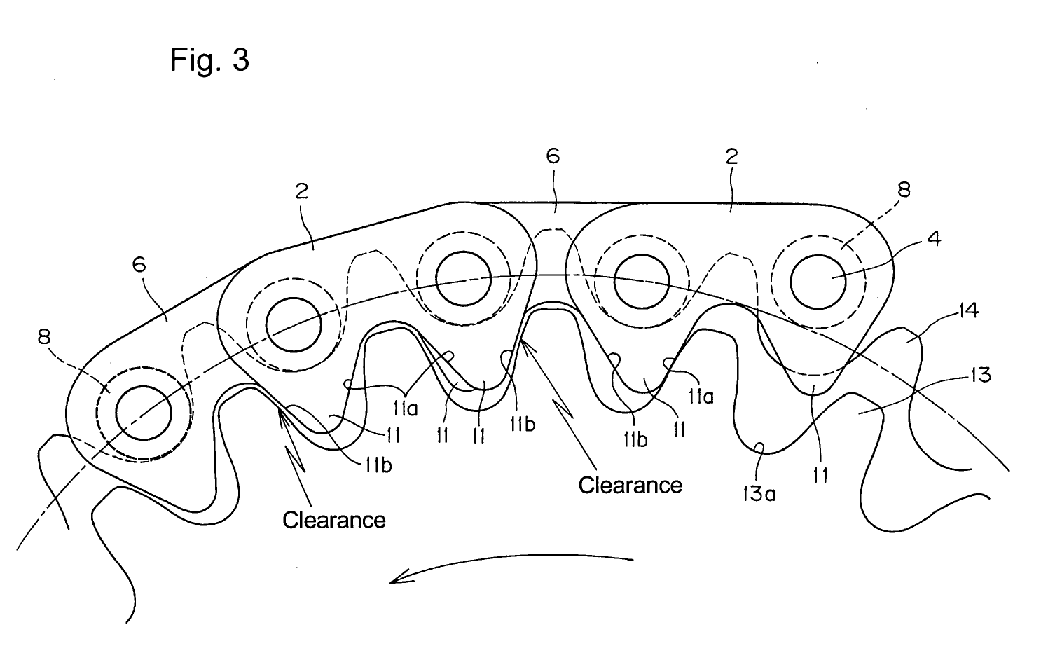

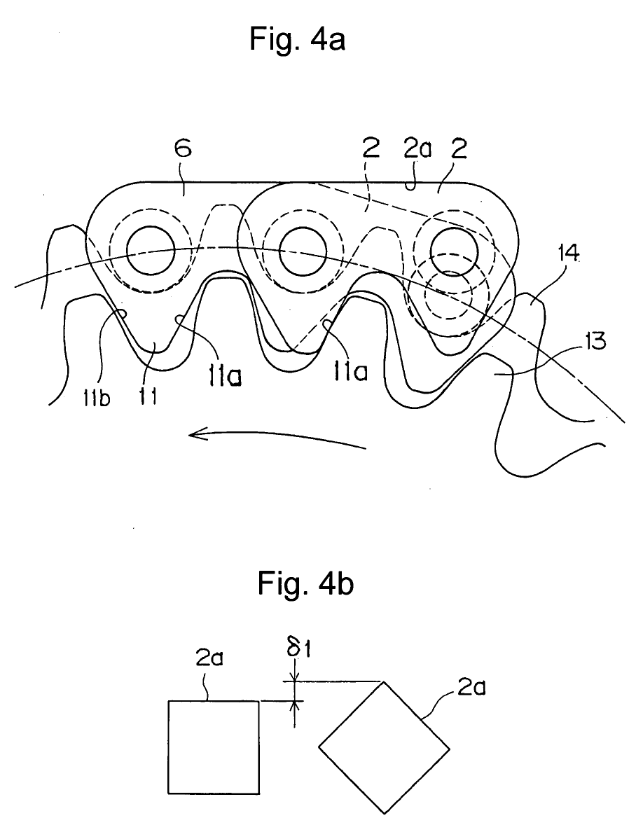

As shown in FIGS. 3 and 4a, an outer link plate 2 and an inner link plate 6 have identical contours. Each is bifurcated so that it has a pair of teeth 11. The teeth have outer flanks 11b, and inner flanks 11a.

As shown in FIG. 2, a sprocket 12 of the transmission comprises three sets of sprocket teeth. First and second sets of sprocket teeth 13 are disposed on opposite sides of a third set of sprocket teeth 14, and the diameter of the third set of sprocket teeth is greater than the diameter of the first and second sets. When the chain 1 is in mesh with the sprocket, the rollers 8 mesh with teeth 14, fitting into the gaps between the teeth, the teeth 11 of the link plates on one side of the chain mesh with one set of sprocket teeth 13, and the teeth 11 of the link plates on the other side of the chain mesh with the other set of sprocket teeth 13. In a typical chain transmission, the chain will be in mesh with a driving sprocket and with one or more driven sprockets. The teeth of the outer link plates 2 and the teeth of the inner link plates 6 mesh in exactly the same way with sprocket teeth 13.

Referring to FIGS. 3 and 4a, as the chain 1 approaches the sprocket, an inner, or rear, flank 11a of a forward tooth 11 of a link plate 2 comes into contact with a first sprocket tooth 13, and the inner flank 11a slides along the sprocket tooth as the forward tooth moves toward the tooth gap bottom 13a. The forward tooth of each of the link plates 6 comes into contact with the sprocket teeth 13 in the same way that the forward tooth of each of the link plates 2 comes into contact with the sprocket teeth. As the forward tooth moves toward the tooth gap bottom, a roller 8, which is adjacent the rear tooth of the link plate, moves toward the intermediate sprocket, into a space between two adjacent sprocket teeth 14 where the roller becomes seated.

When the roller 8 is seated, the inner flank 11a of the forward tooth 11 moves away from the sprocket tooth 13 so that, when the roller adjacent the rear tooth of the link plate becomes seated, neither the inner nor outer flanks of the teeth 11 of the link plate are in contact with the sprocket teeth 13. As shown in FIG. 3, clearances are formed between both outer flanks 11b and the sprocket teeth 13.

Because at the start of meshing, the inner flank of a link plate tooth comes into contact with a sprocket tooth 11, noise at the start of meshing is suppressed. Noise on meshing of the roller 8 is also reduced, and, at the same time wear of the sprocket teeth 14 is suppressed. The surface pressure between the connecting pins and the bushings 9 is small, and pivotal movements of the links 5 and 10 are carried out smoothly. Thus, wear elongation of the chain can be suppressed.

As the chain is wound around the sprocket it moves up and down in a range δ1 as a result of polygonal movement of the chain as shown schematically in simplified form in FIG. 4b, where 2a represents the back of an outer link plate 2. However, since the inner flanks 11a of the teeth 11 of the link plates come into contact with sprocket teeth 13 at the start of meshing engagement, engagement noise is suppressed.

As the rollers 8 become seated, the teeth 11 of the link plates 2 and 6 are spaced away from the sprocket teeth 13. Thus the load on the chain is not applied to the teeth 11, and the fatigue strength of the chain is the same as that of the roller chain.

The number of link plates 2 and 6 in the direction of the width of the chain 1 is only four. Thus, the chain is lighter in weight than the conventional composite chain, and a cost reduction can be achieved.

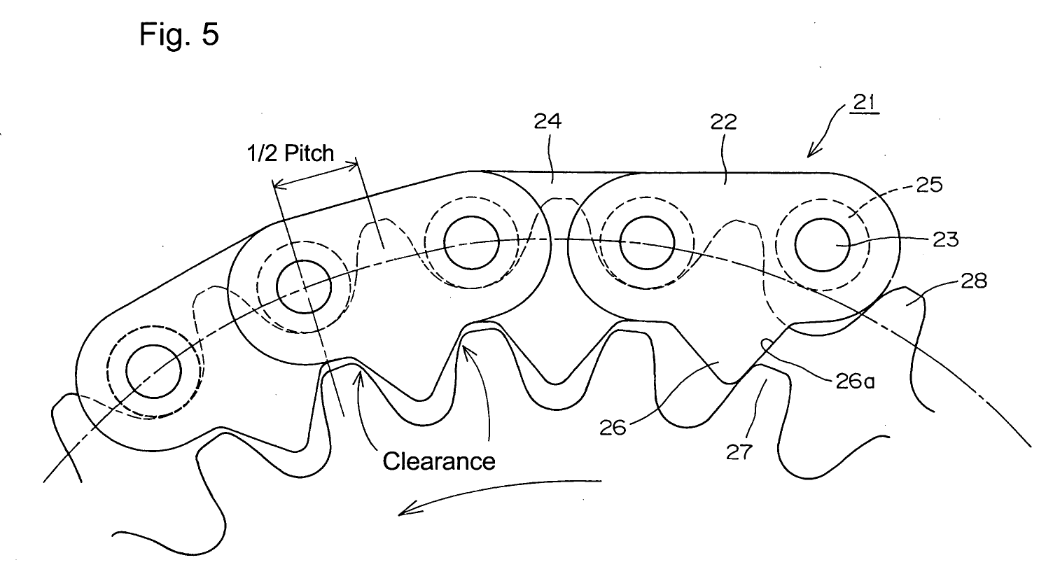

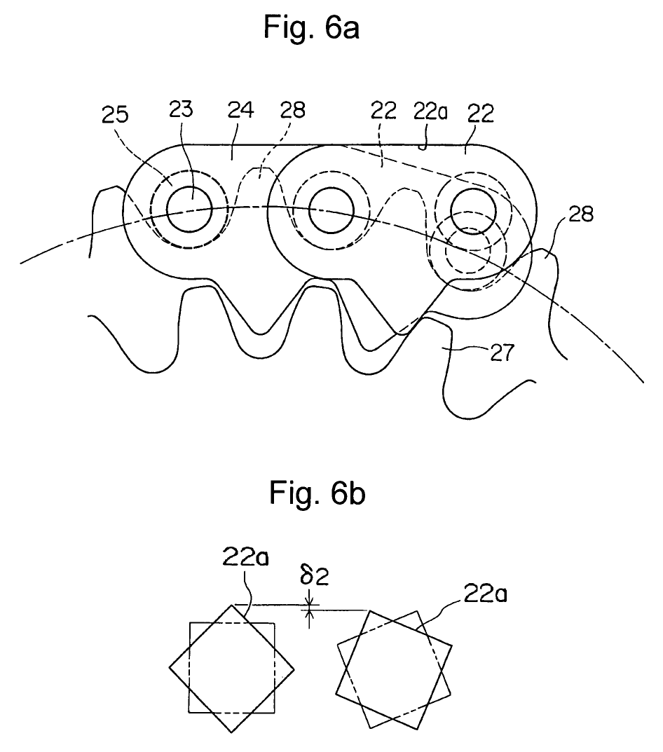

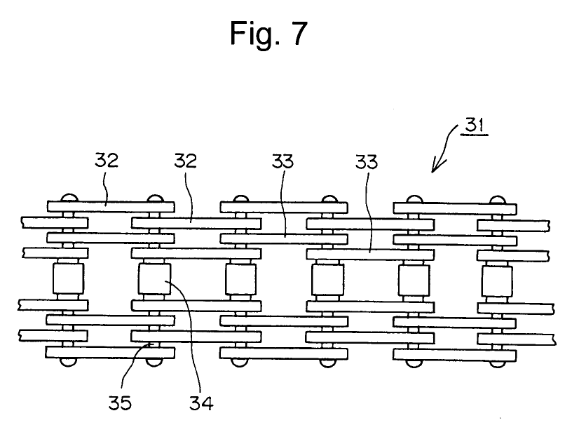

In the second embodiment of the invention, as shown in FIGS. 5 and 6, each link plate has a single angle-shaped tooth formed thereon.

The chain 21, shown in FIG. 5, is similar to the chain in FIG. 3 in that it comprises outer links and inner links arranged in alternating relationship along the length of the chain. Each outer link comprises a pair of opposite link plates 22 connected by a pair of connecting pins 23. The ends of the connecting pins are fitted into pin holes in the outer link plates 22. Each inner link comprises a pair of inner link plates 24, connected by bushings which are fitted into bushing holes in the inner link plates. Rollers 25 are situated on the bushings between the inner link plates, and are rotatable on the bushings. Pins of the outer links extend through bushings of the inner links. The pins and bushings connect the inner and outer links in alternating relationship to produce a transmission chain in the form of an endless loop. The pins are rotatable in the bushings so that the links are articulable relative to one another, thereby allowing the chain to flex so that it can be wound around a sprocket.

As shown in FIGS. 5 and 6a, the outer link plates 22 of the outer link and the inner link plates 24 of the inner link have identical contours, and each has a single, angle-shaped tooth 26 protruding from a central location between the ends of the link plate. The teeth 26 has flanks 26a.

A sprocket around which the chain 21 is wound includes central sprocket teeth 28 for meshing with rollers 25 of the chain 21, and outer sprocket teeth 27 on both sides, for meshing with the teeth 26 of the link plates. The sprocket teeth 27 and 28 have the same pitch angle, and teeth 27 are shifted by ½ the pitch angle from teeth 28. As in the first embodiment, in the transmission, the chain 21 is typically in mesh with a driving sprocket and one or more driven sprockets.

When a driving sprocket around which the chain 21 is wound is rotated, the chain 21 progresses by meshing the respective teeth 26 of the outer link plates 22 and inner link plates 24 with sprocket teeth 27. The teeth of the outer link plate 22 and the teeth of the inner link plate 24 mesh in the same way with the sprocket teeth 27.

As the chain approaches the sprocket, a rear flank 26a of a tooth 26 comes into contact with a sprocket tooth 27, as shown in FIGS. 5 and 6a. The flank 26a slides on the sprocket tooth as the link plate tooth 26 moves toward a tooth gap bottom 27a. As the link plate tooth slides on the sprocket tooth, a roller 25, adjacent the trailing end of the link plate comes into contact with a sprocket tooth 28 and enters the space between that sprocket tooth and a preceding sprocket tooth, ultimately becoming seated on the intermediate sprocket between the pair of teeth 28. As the roller 25 becomes seated, the flank 26a of tooth 26 moves away from the sprocket tooth 27, and when the roller is seated, the tooth 26 is spaced from the sprocket teeth 27 between which it is situated, the clearances being illustrated in FIG. 5.

As in the case of the first embodiment, in the second embodiment, because at the start of meshing, the inner flank of a link plate tooth comes into contact with a sprocket tooth 27, noise at the start of meshing is suppressed. Noise on meshing of the roller 25 is also reduced, and, at the same time wear of the sprocket teeth 28 is suppressed. The surface pressure between the connecting pins and the bushings is small, and pivotal movements of the inner and outer links and are carried out smoothly. Thus, wear elongation of the chain can be suppressed.

As shown schematically in FIG. 6b, when the chain 21 is wound around a sprocket, the vertical movement 62, resulting from polygonal movement of the chain, is smaller than the vertical movement δ1 in the case of the first embodiment. Chordal vibration noise due to the polygonal movement of the chain is therefore reduced, and meshing noise is also further reduced. As the rollers 25 become seated, the teeth 26 of the link plates 2 and 6 are spaced away from the sprocket teeth 27. Thus the load on the chain is not applied to the teeth 26, and the fatigue strength of the chain can be the same as that of the roller chain.

As in the case of the first embodiment, the number of link plates in the widthwise direction of the chain is only four, and consequently the chain can be made lighter in weight than the composite chain, and a cost reduction can be achieved.

It should be understood that various modifications can be made to the chain transmission described. For example, although the embodiments described utilized roller chains, the advantages of the invention can be realized in chain transmissions using rollerless bushing chains, i.e., chains in which the bushings themselves come into direct contact with sprocket teeth.

I claim:

1. A chain transmission comprising:
a chain comprising alternating outer and inner links, each outer link comprising a pair of spaced outer link plates connected by a pair of pins the ends of which are fitted to pin holes in the outer link plates, and each inner link comprising a pair of spaced inner link plates connected by a pair of bushings fitted into bushing holes in the inner link plates, wherein each pin of an outer link extends rotatably though a bushing of an adjacent inner link, whereby the chain comprises overlapping inner and outer link plates on one side of the chain, overlapping inner and outer link plates on the opposite side of the chain, and
sprocket-engaging elements extending, between the inner link plates, from one side of the chain to the other, said sprocket engaging elements being from the group consisting of said bushings by themselves, and said bushings together with rollers rotatable on said bushings;
sprocket-engaging teeth formed on said inner and outer link plates;
a sprocket having first and second sets of sprocket teeth, teeth of the first set being in meshing engagement with sprocket-engaging teeth on the inner and outer link plates on one side of the chain, and teeth of the second set being in meshing engagement with sprocket-engaging teeth on the inner and outer link plates on the opposite side of the chain;
the sprocket having a third set of teeth disposed between said first and second sets of teeth and in meshing engagement with elements of said sprocket-engaging elements, said elements being seatable between teeth of said third set as said elements come into meshing engagement with the teeth of the third set;
wherein, a rear flank of a tooth of each link plate is engageable with a forward flank of a tooth of one of said first and second sets of sprocket teeth as the link plates first come into contact with the sprocket; and
wherein, as the sprocket-engaging elements of each link become seated between teeth of said third set, the flanks of the link plates thereof are spaced away from the teeth of the first and second sets of sprocket teeth.

2. A chain transmission according to claim 1, in which each of said link plates has two sprocket-engaging teeth formed thereon, and in which the rear flank of a tooth of each link plate engageable with a forward flank of a tooth of one of said first and second sets of sprocket teeth is a rear flank of a forward one of the two teeth thereof with respect to the direction of travel of the chain.

3. A chain transmission according to claim 1, in which each said link plate has a single tooth formed thereon.

4. A chain transmission according to claim 3, in which the teeth of the first, second and third sets of sprocket teeth have the same angular pitch, and in which the teeth of the third set are shifted by ½ the pitch angle relative to the teeth of the first and second sets.
